(19) United States
(12) Patent Application Publication
(10) Pub. No.: US 2026/0049186 A1
(43) Pub. Date: Feb. 19, 2026

(54) SINGLE-ION CONDUCTING MATERIAL

(71) Applicant: Sumitomo Chemical Co., Ltd, Tokyo (JP)

(72) Inventors: Antonio Attanzio, Godmanchester (GB); Thomas Johannes Kugler, Godmanchester (GB); Konrad Zalewski, Godmanchester (GB)

(21) Appl. No.: 19/103,032

(22) PCT Filed: Aug. 4, 2023
(86) PCT No.: PCT/EP2023/071625

§ 371 Date: Feb. 11, 2025

(30) Foreign Application Priority Data
Aug. 11, 2022 (GB) 2211749.3

(51) Int. Cl. C08G 77/60; H01M 10/054; H01M 10/058; H01M 50/414

(52) U.S. Cl. CPC C08G 77/60; H01M 10/054; H01M 10/058; H01M 50/414

(57) ABSTRACT

A single-ion conducting material comprising a plurality of units of formula (I): (I) wherein X is Al or B; M is a cation; the single-ion conducting material comprises X groups of formula (I) linked by a group of formula (II) wherein n is greater than 1 and each R1 independently is an organic residue: (II) and the single-ion conducting material comprises X groups of formula (I) substituted with at least one group of formula OR² wherein R² is an organic substituent which is not bound a further X. The single-ion conductive material may be used in a metal battery or metal ion battery.

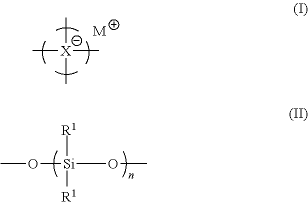

### BACKGROUND

Embodiments of the present disclosure relate to single-ion conducting (SIC) materials, methods of making SIC materials and batteries containing said SIC materials.

Single-ion conducting networks are known.

US 2022/045332 discloses an anode including a current collector and an interfacial layer disposed over the current collector. The interfacial layer includes an ion-conductive organic network including anionic coordination units, organic linkers bonded through the anionic coordination units, and counterions dispersed in the ion-conductive organic network.

JP 3358791 discloses a material having formula:

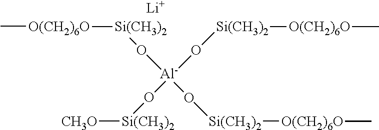

JP3459031 discloses a material having formula:

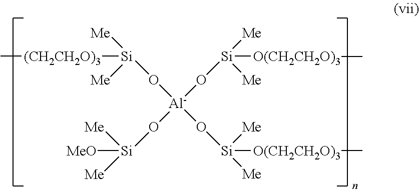

### SUMMARY

In one aspect, the present disclosure provides a single-ion conducting material comprising a plurality of units of formula (I):

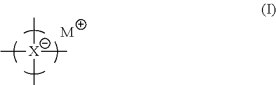

wherein:
X is Al or B;
M is a cation;
the single-ion conducting material comprises X groups of formula (I) linked by a group of formula (II) wherein n is greater than 1 and each R¹ independently is an organic residue:

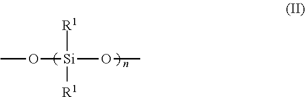

and
the single-ion conducting material comprises X groups of formula (I) substituted with at least one group of formula OR² wherein R² is an organic substituent which is not bound a further X.

Optionally, R² is selected from the group consisting of unsubstituted or substituted phenyl or C₁₋₂₀ alkyl wherein one or more non-adjacent, non-terminal C atoms of the C₁₋₂₀ alkyl may be replaced with O, S, CO or COO and one or more H atoms of the C₁₋₂₀ alkyl may be replaced with F.

Optionally, R² is an optionally fluorinated C₁₋₁₂ alkyl group.

Optionally, R¹ is a C₁₋₁₂ hydrocarbyl group.

Optionally, M⁺ is Li⁺.

Optionally, M⁺ is a solvated cation.

Optionally, the solvent of the solvated cation is selected from C₂₋₁₀ alkylene carbonates; di(C₁₋₁₀ alkyl) carbonates; and linear or cyclic compounds containing one or more ether groups.

In another aspect, the present disclosure provides a method of forming a single-ion conductive material as described herein, the method comprising reaction of a compound of formula (III) with a compound of formula (IV) and a compound of formula (V):

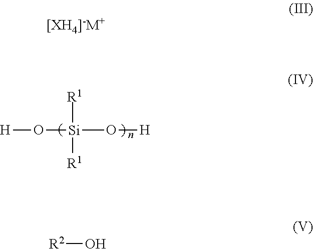

wherein R² comprises only one hydroxyl group.

Optionally, a molar percentage of the compound of formula (IV) as a total of the number of moles of compounds of formulae (IV) and (V) is at least 5%.

Preferably, the single-ion conducting material is a single-ion conducting network.

In another aspect, the present disclosure provides a single-ion conducting material obtainable by the method described herein.

In another aspect, the present disclosure provides a metal battery or metal ion battery comprising an anode, a cathode and a single-ion conducting material as described herein disposed between the anode and cathode.

In another aspect, the present disclosure provides a method of forming a metal battery or metal ion battery as described herein comprising deposition of a formulation comprising the single-ion conducting material dissolved or dispersed in a deposition solvent onto a surface and evaporating the deposition solvent.

### DESCRIPTION OF DRAWINGS

FIG. 1 is a schematic illustration of a battery having a separator comprising a single-ion conductive material as described herein;

FIG. 2 is a schematic illustration of a battery having an anode protection layer comprising a single-ion conductive material as described herein;

FIG. 3 shows NMR spectra showing differences between a reaction mixture for forming a single-ion conducting network and the resultant product;

FIG. 4 is Nyquist plots for single-ion conducting networks formed by reaction of LiAlH₄ and hydroxy-terminated poly(dimethylsulfoxide) (PDMS) with 6 moles of propylene carbonate and with 8 moles of propylene carbonate;

FIG. 5 is a plot of ionic conductivity vs. propylene carbonate/Li⁺ ratio for the SIC networks of FIG. 4;

FIG. 6 is Nyquist plots for cells containing single-ion conducting networks formed by reaction of LiAlH₄, hydroxy-terminated PDMS and 2,2,3,3,4,4,5,5-Octafluoro-1-pentanol (OFP) with PDMS:OFP ratios of 1.25:1.5 (Example 1), 1:2 (Example 2) and 0.5:3 (Example 3);

FIG. 7 is a plot of ionic conductivity PDMS:OFP ratio for Examples 1, 2 and 3;

FIGS. 8A and 8B are, respectively, Nyquist plots and DC current measurements used to determine the lithium transference number for a cell containing Comparative Example 1;

FIGS. 9A and 9B are, respectively, Nyquist plots and DC current measurements used to determine the lithium transference number for a cell containing Comparative Example 2;

FIGS. 10A and 10B are, respectively, Nyquist plots and DC current measurements used to determine the lithium transference number for a cell containing Example 1;

FIGS. 11A and 11B are, respectively, Nyquist plots and DC current measurements used to determine the lithium transference number for a cell containing Example 2; and

FIGS. 12A and 12B are, respectively, Nyquist plots and DC current measurements used to determine the lithium transference number for a cell containing Example 3.

The drawings are not drawn to scale and have various viewpoints and perspectives. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising.” and the like are to be construed in an inclusive sense, as opposed to an exclusive or exhaustive sense; that is to say, in the sense of “including, but not limited to.” Additionally, the words “herein,” “above.” “below.” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present disclosure provides a single-ion conducting material comprising a plurality of units of formula (I):

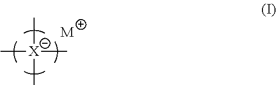

M is a cation, preferably an alkali metal cation, more preferably Li⁺.

X is Al or B. The single-ion conductive material may contain only one of Al and B anions. The single-ion conductive material may contain both of Al and B anions.

The single-ion conducting material includes X groups which are linked by a group of formula (II) wherein n is greater than 1 and each R¹ independently is an organic residue:

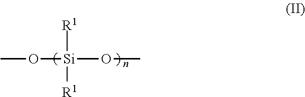

n is preferably at least 5, optionally 5-20, more preferably 6-12. n=8-10 is particularly preferred.

n is a number average value which may be determined from the number average molecular weight of a siloxane oligomer or polymer having —(Si(R¹)₂—O)— repeat units.

The single-ion conducting material includes X groups substituted with at least one group of formula OR² wherein R² is a monovalent organic substituent. It will be understood that OR² is bound to one X group only.

At least some X⁻ anionic centres, and preferably each of the X⁻ anionic centres, is independently linked to 1, 2, 3 or 4 groups of formula (II) and it will be understood that there will typically be a distribution between integers of 1-4 for the number of groups of formula (II) that the X⁻ centres of single-ion conducting material are linked to.

The single-ion conducting material is preferably a single-ion conducting network. By “single-ion conducting network” as used herein is meant a single-ion conducting material in which a plurality of X⁻ centres are each linked to two, three or four further X⁻ centres.

The X centres of a single-ion conducting network are preferably linked only by groups of formula (II). In other embodiments, the single-ion conducting network may contain one or more further linking groups. The one or more further linking groups may have formula (VI):

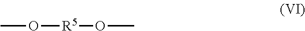

wherein R⁵ is a C₁₋₃₀ alkylene chain in which or more C atoms, other than C atoms adjacent to the O atoms at the termini of formula (VI), may be replaced with O or S and one or more H atoms may be replaced with F.

The degree of interlinking between X⁻ centres depends on the ratio of groups of formula (II) and other linking groups, if present, and monovalent groups of formula OR².

The degree of interlinking between X⁻ centres may be expressed as a mean average number of linking groups, including but not limited to the number of groups of formula (II), per X⁻ centre. This value is preferably at least 2. This value may be determined from a ratio of monohydric alcohol to diol used in forming the single-ion conducting network, assuming that all of the monohydric alcohol and diol is consumed in the reaction.

The degree of interlinking may be selected according to the desired properties of the single-ion conductive network. Properties of the network which may be changed as compared to a fully interlinked network include, without limitation, one or more of porosity and mechanical strength. These properties may in turn influence the ionic conductivity of the single-ion conductive network.

The molar percentage of groups of formula (II) as a total of the number of moles of formula (II) and moles of OR² is preferably at least 5% optionally at least 10%. Preferably, the molar percentage of groups of formula (II) as a total of the number of moles of formula (II) and moles of OR² is no more than 75% or no more than 50%.

Each R¹ may be the same or different, preferably the same. R¹ may be selected from substituted or unsubstituted aryl or heteroaryl, preferably substituted or unsubstituted phenyl; and C₁₋₁₂ alkyl wherein one or more non-adjacent C atoms other than the C atoms bound to Si and the terminal C atom or atoms may be replaced with O, S, CO, COO, NR³ or Si(R⁴)₂ wherein R³ in each occurrence is H a substituent, preferably a C₁₋₁₂ hydrocarbyl group, and R⁴ is a substituent, preferably a C₁₋₁₂ hydrocarbyl group.

R² may be selected from the group consisting of substituted or unsubstituted aryl or heteroaryl, preferably substituted or unsubstituted phenyl, or branched, linear or cyclic C₁₋₂₀ alkyl wherein one or more non-adjacent, non-terminal C atoms of the C₁₋₂₀ alkyl may be replaced with O, S, CO, COO, NR³ or Si(R⁴)₂ and one or more H atoms of the C₁₋₂₀ alkyl may be replaced with F.

In a preferred embodiment, R² is an optionally fluorinated C₁₋₁₂ alkyl group.

An aryl or heteroaryl group R¹ or R² may be substituted with one or more substituents selected from F, Cl, NO₂, CN and C₁₋₁₂ alkyl wherein one or more non-adjacent, non-terminal C atoms may be replaced with O, S, CO, COO, NR³ or Si(R⁴)₂ wherein R³ and R⁴ are as described with respect to R¹.

A C₁₋₁₂ hydrocarbyl group as described anywhere herein is preferably selected from C₁₋₁₂ alkyl; phenyl; and phenyl substituted with one or more C₁₋₆ alkyl groups.

By “non-terminal C atom” of an alkyl chain is meant the methyl group at the chain end of a linear alkyl chain or each one of the methyl groups at the chain ends of a branched alkyl group.

Preferably, M⁺ is a solvated cation. The solvent of the solvated cation is selected from solvents comprising at least one ether group.

The solvent may be selected from C₂₋₁₀ alkylene carbonates, di(C₁₋₁₀ alkyl) carbonates, linear and cyclic compounds containing one or more ether groups and, optionally, one or more groups selected from hydroxyl and carboxylate groups.

Exemplary solvents include, without limitation, propylene carbonate, ethylene carbonate, dimethyl carbonate, tetrahydrofuran, dimethoxyethane, diglyme (diethylene glycol dimethyl ether), triglyme (triethylene glycol dimethyl ether), tetraglyme (tetraethylene glycol dimethyl ether) and crown ethers, for example 12-Crown-4 and 1-aza-12-Crown-4.

Optionally, the single-ion conducting material contains at least 0.5 moles of solvent per mole of M⁺, preferably at least 1 mole of solvent per mole of M⁺. Optionally, the single-ion conducting material contains no more than 20 moles or no more than 12 moles of solvent per mole of M⁺, more preferably no more than 8 moles of solvent per mole of M⁺.

The single-ion conductive material described herein may be formed by reaction of a compound of formula (III) with a diol compound of formula (IV) and a monohydric alcohol compound of formula (V):

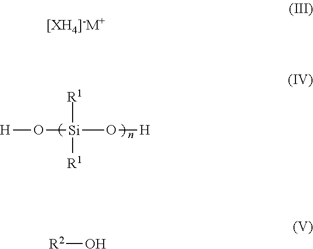

wherein X, M⁺, R¹ and R² are as described above.

Preferably, the compound of formula (IV) is the only diol reactant. In other embodiments, one or more further diols of formula HO—R⁵—OH may be present in which R⁵ is as described above.

The reaction can be carried out in a “one-pot” process, and the only by-product is hydrogen gas so no purification steps are required following the reaction.

Each of the alcohol groups of the diol of formula (IV) are capable of forming a bond to X, thereby forming links between X groups, whereas the monohydric alcohol of formula (V) is capable of forming a bond to one X only. Therefore, the extent of crosslinking of the single-ion conducting network may be controlled by selecting the molar ratio of the monohydric alcohol of formula (V):diol including a compound of formula (IV). Optionally, the molar percentage of diol, including the compound of formula (IV), as a total of the number of moles of diol and compound of (V) is at least 5% optionally at least 10 and is preferably no more than 75% or no more than 50%.

The proportion of diol which is a compound of formula (IV) is preferably at least 50 mol %, more preferably 100%.

It will be understood that the single-ion conducting material formed by the reaction described herein will have a molecular weight distribution. The reaction product may, in addition to the single-ion conducting material described herein, contain a compound of formula [X(OR²)₄]⁻ M⁺. It will be appreciated that a larger proportion of the compound of formula (V) in the formula (V):diol ratio will increase the proportion of [X(OR²)₄]⁻M⁺ in the product.

Preferably, any product of formula [X(OR²)₄]⁻M⁺ is not separated from the single-ion conducting material described herein prior to its use in a metal or metal ion battery.

### Applications

A single-ion conducting material as described herein may be provided in a battery. The battery may be, without limitation, a metal battery or a metal ion battery, for example a lithium battery or a lithium ion battery.

A single-ion conducting material as described herein may be a component of a composite comprising one or more additional materials, for example a compound of formula [X(OR²)₄]⁻ M⁺. A layer comprising or consisting of single-ion conducting material may be formed by depositing a formulation containing the single-ion conducting material dissolved or dispersed in a solvent or solvent mixture followed by evaporation of the solvent or solvents.

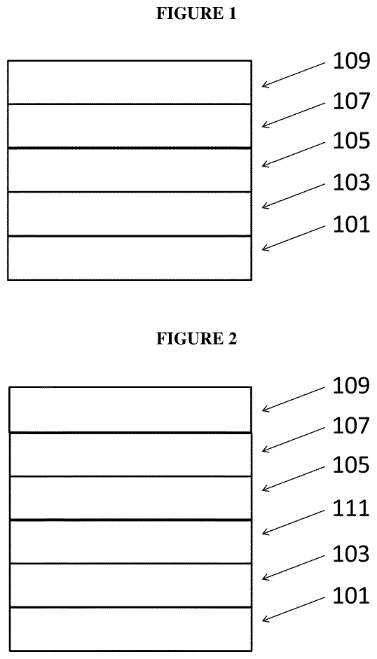

FIG. 1 illustrates a battery comprising an anode current collector 101 carrying an anode 103 on a surface thereof; a cathode current collector 109 having a cathode 107 disposed on a surface thereof; and a separator 105 disposed between the anode and cathode. The separator comprises or consists of a single-ion conductive material as described herein.

In the case of a metal battery, the anode is a layer of metal (e.g. lithium) which is formed over the anode current collector during charging of the battery and which is stripped during discharge of the battery.

In the case of a metal ion battery, the anode comprises an active material, e.g. graphite, for absorption of the metal ions.

The cathode may be selected from any cathode known to the skilled person.

The anode and cathode current collectors may be any suitable conductive material known to the skilled person, e.g. one or more layers of metal or metal alloy such as aluminium or copper.

FIG. 1 illustrates a battery in which the anode and cathode are separated only by a separator. In other embodiments, one or more further layers may be disposed between the anode and the separator and/or the cathode and the separator.

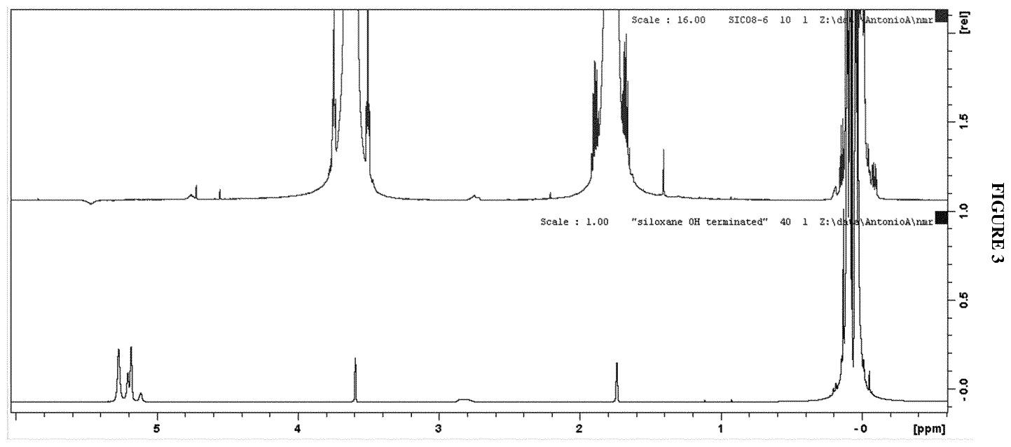

FIG. 2 illustrates a battery, preferably a metal battery, comprising an anode current collector 101 carrying an anode 103 on a surface thereof; a cathode current collector 109 having a cathode 107 disposed on a surface thereof; a separator 105 disposed between the anode and cathode; and an anode protection layer 111 disposed between anode and the separator. The separator may comprise or consist of a single-ion conductive material as described herein or may be any other separator known to the skilled person, for example a porous polymer having a liquid electrolyte absorbed therein. The anode protection layer comprises or consist of a single-ion conductive material as described herein. The anode protection layer may prevent or retard formation of lithium metal dendrites of a metal battery.

In some embodiments, a single-ion conductive material may be used in a battery without any liquid electrolyte absorbed therein.

In some embodiments, an electrolyte is absorbed in the single-ion conductive material described herein.

The electrolyte may be an organic solvent or a blend of organic solvents. The solvent is optionally an alkyl carbonate or a mixture of organic carbonates, for example propylene carbonate, ethylene carbonate, dimethyl carbonate, ethylmethyl carbonate, fluoroethylene carbonate, vinylene carbonate, dimethoxyethane, diglyme, triglyme, tetraglyme, tetrahydrofuran, dioxolane, acetonitrile, adiponitrile, dimethylsulfoxide, dimethylformamide, nitromethane, N-methylpyrrolidone, ionic liquids, deep eutectic solvents and mixtures thereof.

A salt having a metal cation may be dissolved in the electrolyte solvent, for example lithium bis(trifluoromethylsulfonyl)imide (LiTFSI) Li or lithium hexafluorophosphate bis(fluorosulfonyl)imide (LiFSI), LiAsF₆, LiSbF₆, LiClO₄, Li bisoxalatoborane, LiBF₄, LiNO₃, Li halides, Li dicyanamide and combinations thereof.

A layer comprising or consisting of a single-ion conducting material as described herein may be formed by deposition of a formulation comprising the single-ion conducting material dissolved or dispersed in a deposition solvent. The deposition solvent may be a single solvent material or a mixture of solvent materials.

In the case of a lithium battery, in some embodiments a layer comprising a single-ion conducting material is deposited directly onto an anode current collector to form a precursor battery. Upon application of a potential difference across the anode and cathode, a lithium anode layer may form between the anode current collector and the layer comprising the single-ion conducting material.

Following deposition, the deposition solvent is removed by evaporation. Evaporation may be conducted under heat and/or vacuum treatment. If any solvating solvent is present in the formulation then the solvating solvent preferably has a boiling point at least 50° C. or 100° C. higher than the or each deposition solvent material. Heat treatment is suitably at least 50° C. or at least 100° C. below a boiling point of the solvating solvent.

Optionally, a cell as described herein preferably contains no more than 12 moles or no more than 8 moles of solvent per mole of M⁺.

### EXAMPLES

### Comparative Examples 1 and 2

A fully crosslinked single-ion conducting network was formed according to the following procedure:

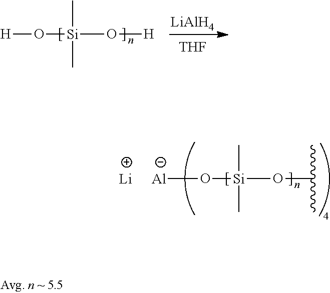

0.5 ml of poly(dimethylsiloxane), hydroxy terminated and 3 mL THF were added to a 40 mL vial in a nitrogen-filled glovebox with sub-ppm O₂ and H₂O levels. 0.6 mL 1M LiAlH₄ in THF was added dropwise into the vial under continuous stirring. The resulting product following evaporation of the solvent is a gel.

Completion of the reaction was followed by NMR (FIG. 3) which shows the disappearance in the product of the OH peak at about 5.2 ppm confirming the formation of the product.

After completion of the reaction propylene carbonate (PC) was added to the solution to provide single-ion conducting networks with 6 and 8 PC molecules per Li⁺ to give Comparative Examples 1 and 2, respectively.

### Examples 1-3

A reaction and subsequent addition of PC was performed as described for Comparative Example 1 but with inclusion of varying amounts of 2,2,3,3,4,4,5,5-Octafluoro-1-pentanol (OFP) as set out in Table 1:

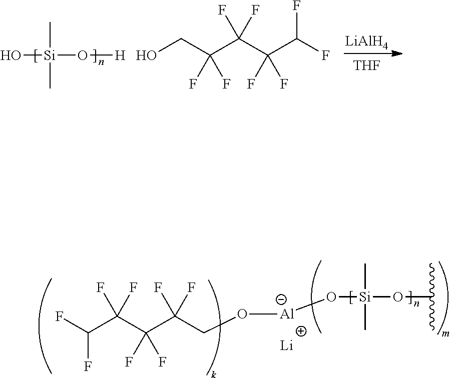

TABLE 1

| | Molar | Molar | | |
|---|---|---|---|---|
| | equivalents | equivalents | Molar % | PC/Li+ |
| Example | of siloxane | of OFP | of OFP | molar ratio |
| 1 | 1.25 | 1.5 | 55 | 6 |
| 2 | 1 | 2 | 67 | 6 |
| 3 | 0.5 | 3 | 87 | 6 |

All products of Examples 1, 2 and 3 are flowable liquids even after removal of the THF reaction solvent.

### Electrochemical Impedance Spectroscopy (EIS)—Comparative Examples

EIS was performed using 2032-type coin cells (Cambridge Energy Solutions) to measure conductivity of Comparative Examples 1 and 2.

To form the cells, Comparative Example 1 or 2 was drop cast (4×100 microlitres, 1 minute apart, hotplate at 30° C.) on top of a lithium disk (50 microns thick, 15.6 mm in diameter), left to dry and then cut using a manual cutter into a disk of 0.8 cm in diameter. The film was dried for 30 min at 30° C. and then for further 60 min at 60° C. Drying the film at 30-60° C. allows full evaporation of THF solvent, but not of PC (boiling point 240° C.), which remains part of the gel.

The lithium disk carrying the gel was inserted in a 9 mm diameter circular hole in the middle of a silicon stencil of 400 microns thickness and diameter 160 mm supported on a lower stainless steel disk.

On top of the stencil a second lithium disk was placed followed by an upper stainless-steel disk. This structure, contained within a coin cell top and bottom and with a wave spring between the upper stainless steel disk and the coin cell top, was crimped.

The overall thickness of the layer of the gel of Comparative Example 1 or 2 was the thickness of the 400 micron stencil minus the 50 micron thickness of the lithium disk. The use of the stencil allowed accurate control the film thickness of the soft gel of Comparative Example 1 or 2 which would otherwise have been squeezed after the cell crimping causing the device to short.

All coin cell devices were assembled in a rigorously dry and oxygen-free Argon gas-filled MBraun glovebox.

EIS measurements were conducted at room temperature. The EIS measurements were taken over a frequency range of 1 Hz to 1 MHz with an amplitude of 5 mV.

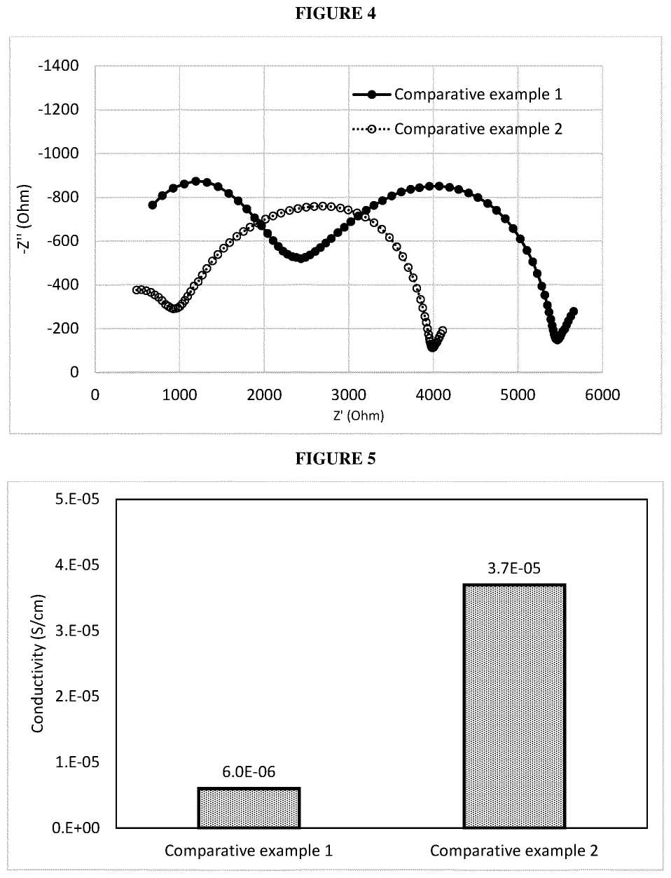

Ionic conductivities were calculated using the following formula:

$$σ = \frac{l}{A \cdot R}$$

where l is the thickness of the material between the two lithium disks which corresponds to the difference of the stencil minus the thickness of the lithium, A is the area of the film and R is the impedance. The impedance of the cell is determined by estimating the intercept on the x-axis of the Nyquist plot of the first semicircle (FIG. 4, bottom left corner).

Conductivity values are shown in FIG. 5.

### Electrochemical Impedance Spectroscopy (EIS)—Examples 1-3

Conductivities for Examples 1-3 were conducted on 2032-type coin cells which were prepared as described for the Comparative Examples with modifications due to the liquid nature of Examples 1-3.

Cells were fabricated by inserting a stainless steel spacer in a coin cell bottom, followed by a lithium disk and a fluoro-silicone stencil (purchased from Silex Silicones). The stencil was shaped as a disk of 15.5 mm diameter, with a circular hole of 5 mm diameter cut in its middle (the thickness of the stencil in the crimped cell was 360 μm). The hole was filled with 30 μl of Example 1, 2 or 3. On top of the stencil a lithium disk was placed, followed by a stainless steel spacer, a wave spring and a coin cell top. Finally, the coin cell was crimped.

All coin cell devices were assembled in a rigorously dry and oxygen-free Argon gas-filled MBraun glovebox.

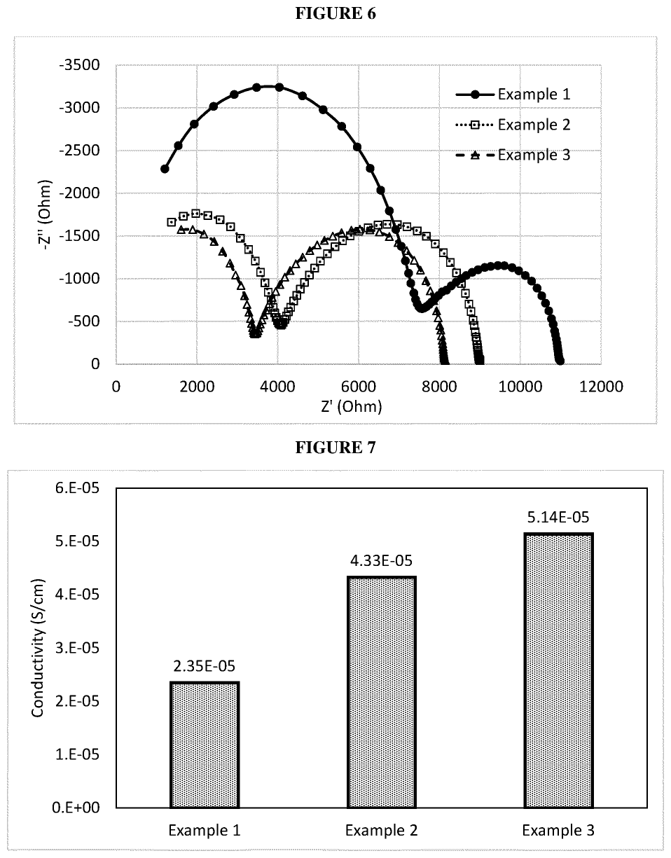

EIS measurements were conducted as described above. Nyquist plots for cells containing Examples 1-3 are shown in FIG. 6.

The ionic conductivities were calculated for the different materials and representative values are shown in FIG. 7, from which it can be seen that the ionic conductivities for Examples 1, 2 and 3, which each contain 6 moles of PC per mole of Li+, are all higher than the conductivity of the Comparative Example 1 with 6 moles of PC. Furthermore, ionic conductivity increases with increasing amount of monohydric alcohol. Without wishing to be bound by any theory, this is believed to be due to a lower degree of crosslinking and a more liquid-like nature of the single-ion conducting network at higher levels of incorporation of the monohydric alcohol which allows for a greater degree of ion mobility.

### Lithium Transference Number (LTN)—Comparative Examples.

LTN measurements were carried out using the same cell configurations described above. LTN was measured according to the method of J. Evans et al., POLYMER, 1987, Vol 28.

The cells were left resting overnight for about 19 hours before performing the LTN measurement in order to ensure stabilisation of the interfaces between the materials and the lithium disks.

After resting, an EIS spectrum was measured followed by a DC voltage measurement (10 mV applied voltage for 3 h) followed by another EIS measurement. LTN was calculated according to the following formula, based on the model developed by Evans et al:

$$LTN = \frac{{I}^{s} ( ΔV - {I}^{0} {R}^{0} )}{{I}^{0} ( ΔV - {I}^{s} {R}^{s} )}$$

where R⁰ is the initial impedance taken from the first EIS spectrum, R^{s} is the steady state impedance taken from the second EIS after a 10 mV DC bias was applied, I⁰ is the initial current taken when the voltage is stepped to 10 mV and I^{s} is the steady state current taken at the end of the DC measurement.

EIS measurements were conducted at room temperature. The EIS measurements were taken over a frequency range of 1 Hz to 1 MHz with an amplitude of 5 mV.

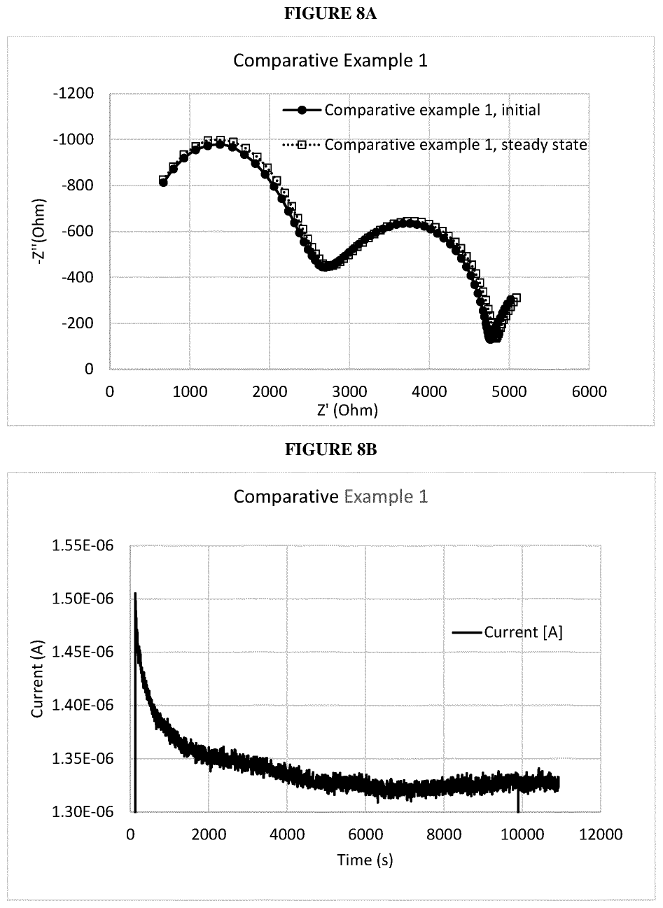

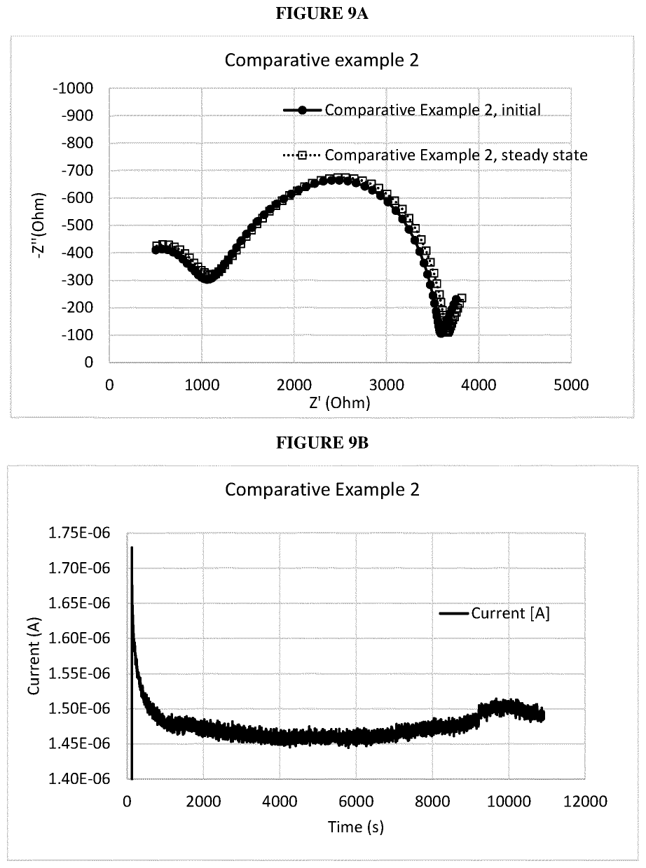

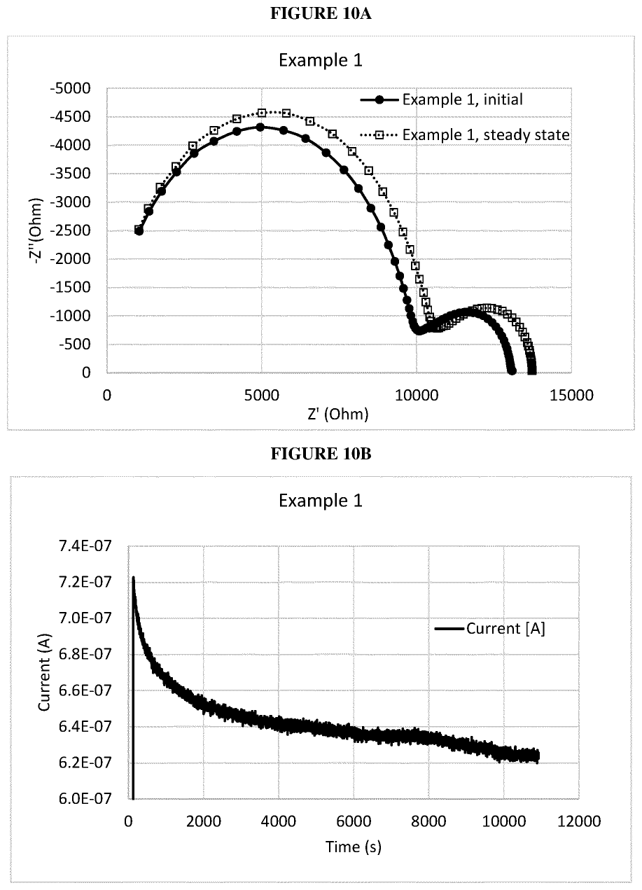

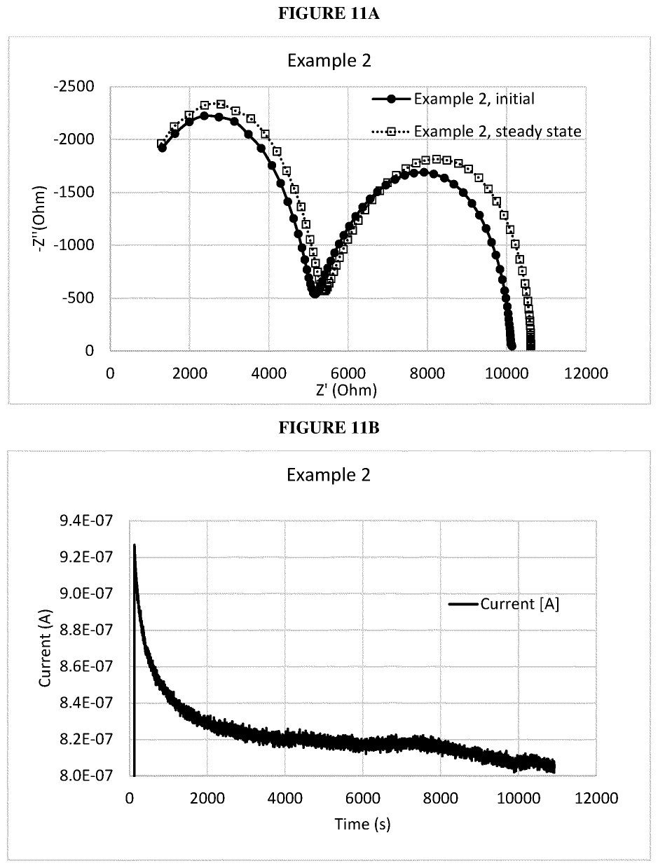

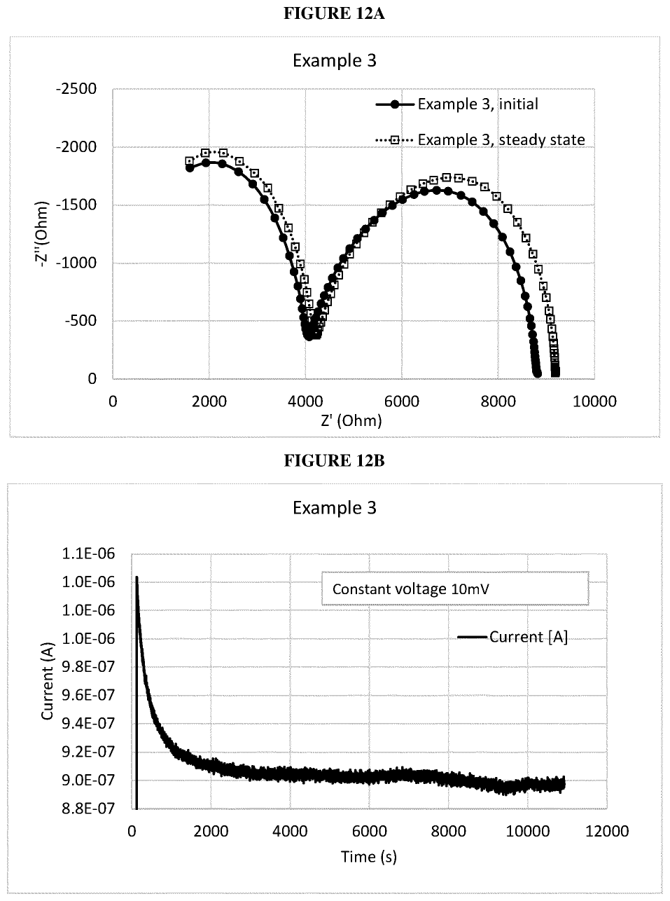

EIS spectra and DC measurements are shown in FIGS. 8-12

The calculated LTN numbers in Table 2 show little variation in LTN values which are all around 0.8. This indicates that the cations are mainly responsible for the current going through the material and that in this series of materials the LTN is not affected by ion solvation as well as degree of crosslinking.

TABLE 2

| | PC/Li+ | Equivalent | |
|---|---|---|---|
| Material | molar ratio | % of OFP | LTN |
| Comparative | 6 | 0 | 0.81 |
| Example 1 | | | |
| Comparative | 8 | 0 | 0.81 |
| Example 2 | | | |
| Example 1 | 6 | 55 | 0.83 |
| Example 2 | 6 | 67 | 0.81 |
| Example 3 | 6 | 87 | 0.77 |

1. A single-ion conducting material comprising a plurality of units of formula (I): 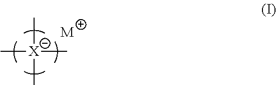
wherein:
X is Al or B;
M is a cation;
the single-ion conducting material comprises X groups of formula (I) linked by a group of formula (II) wherein n is greater than 1 and each R¹ independently is an organic residue: 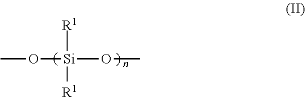
and
the single-ion conducting material comprises X groups of formula (I) substituted with at least one group of formula OR² wherein R² is an organic substituent which is not bound a further X.

2. The single-ion conducting material according to claim 1 wherein R² is selected from the group consisting of unsubstituted or substituted phenyl or C₁₋₂₀ alkyl wherein one or more non-adjacent, non-terminal C atoms of the C₁₋₂₀ alkyl may be replaced with O, S, CO or COO and one or more H atoms of the C₁₋₂₀ alkyl may be replaced with F.

3. The single-ion conducting material according to claim 2 wherein R² is an optionally fluorinated C₁₋₁₂ alkyl group.

4. The single-ion conducting material according to claim 1 wherein R¹ is a C₁₋₁₂ hydrocarbyl group.

5. The single-ion conducting material according to claim 1 wherein M⁺ is Li⁺.

6. The single-ion conducting material according to claim 1 wherein M⁺ is a solvated cation.

7. The single-ion conducting material according to claim 6 wherein the solvent of the solvated cation is selected from C₂₋₁₀ alkylene carbonates; di(C₁₋₁₀ alkyl) carbonates; and linear or cyclic compounds containing one or more ether groups.

8. The single-ion conducting material according to claim 1 wherein the single-ion conducting material is a single-ion conducting network comprising a plurality of the X⁻ groups linked to two, three or four further X⁻ groups.

9. A method of forming a single-ion conductive material according to claim 1 comprising reaction of a compound of formula (III) with alcohols including a compound of formula (IV) and a compound of formula (V): 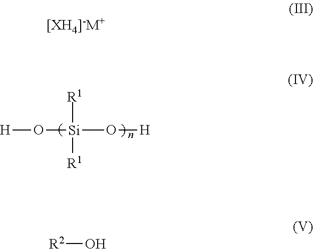
wherein X, M⁺, R¹ and R² are as defined in claim 1 and R² comprises only one hydroxyl group.

10. The method according to claim 9 wherein a molar percentage of the compound of formula (IV) as a total of the number of moles of compounds of formulae (IV) and (V) is at least 5%.

11. A single-ion-conducting material obtainable by the method according to claim 9.

12. A metal battery or metal ion battery comprising an anode, a cathode and a single-ion conducting material according to claim 1 disposed between the anode and cathode.

13. The metal battery according to claim 12.

14. A method of forming a metal battery or metal ion battery according to claim 12 comprising deposition of a formulation comprising the single-ion conducting material dissolved or dispersed in a deposition solvent onto a surface and evaporating the deposition solvent.
